(19) United States
(12) Patent Application Publication
(10) Pub. No.: US 2010/0259015 A1
(43) Pub. Date: Oct. 14, 2010

(54) HYDRODYNAMIC SEAL WITH IMPROVED EXCLUSION AND LUBRICATION

(76) Inventor: Lannie Laroy Dietle, Houston, TX (US)

Correspondence Address: ANDREWS & KURTH, L.L.P., 600 TRAVIS, SUITE 4200, HOUSTON, TX, 77002, US

(21) Appl. No.: 12/756,002

(22) Filed: Apr. 7, 2010

Related U.S. Application Data
(60) Provisional application No. 61/212,179, filed on Apr. 8, 2009.
(60) Provisional application No. 61/283,227, filed on Nov. 30, 2009.
(60) Provisional application No. 61/284,179, filed on Dec. 14, 2009.

(51) Int. Cl. F16J 15/32

(52) U.S. Cl. 277/559

(57) ABSTRACT

A hydrodynamic sealing assembly including a first machine component defining a seal groove and a second machine component having a rotatable surface that is rotatable relative to the first machine component. A hydrodynamic seal including a seal body of generally ring-shaped configuration having a circumference and the seal body includes a sealing lip having a sealing surface contacting the relatively rotatable surface to establish a sealing interface between the sealing lip and the relatively rotatable surface. The sealing lip includes an exclusion edge of abrupt substantially circular form that is substantially aligned with a direction of relative rotation between the sealing lip and the relatively rotatable surface in a compressed, installed condition of the seal and wherein the exclusion edge is non-circular and slightly wavy in an uncompressed, uninstalled condition of the hydrodynamic seal.

### CROSS-REFERENCE TO RELATED APPLICATIONS

This application claims the benefit of U.S. Provisional Application Ser. No. 61/212,179 filed Apr. 8, 2009, entitled “Rotary seal with improved environmental exclusion,” and claims the benefit of U.S. Provisional Application Ser. No. 61/283,277 filed Nov. 30, 2009, entitled “Seal Carrier,” and claims the benefit of U.S. Provisional Application Ser. No. 61/284,179 filed Dec. 14, 2009, entitled “Pressure-balanced floating seal carrier.” Provisional Application Ser. Nos. 61/212,179, 61/283,277, and 61/284,179 are incorporated by reference herein for all purposes.

### BACKGROUND OF THE INVENTION

1. Field of the Invention

This invention relates to hydrodynamic rotary seals that are used to retain lubricant and exclude the environment in diverse applications. More specifically, this invention relates to features that improve exclusion edge circularity and regulate contact pressure at the dynamic sealing interface for improved abrasive exclusion, and improved consistency of hydrodynamic lubrication and flushing action.

2. Description of the Related Art

The following commonly assigned patent documents are related to the invention, and are incorporated herein by reference for all purposes:

United States Patents:

U.S. Pat. No. 7,052,020 Hydrodynamic Rotary Seal;

U.S. Pat. No. 6,767,016 Hydrodynamic Rotary Seal With Opposed Tapering Seal Lips;

U.S. Pat. No. 6,685,194 Hydrodynamic Rotary Seal With Varying Slope;

U.S. Pat. No. 6,561,520 Hydrodynamic Rotary Coupling Seal;

U.S. Pat. No. 6,494,462 Rotary Seal With Improved Dynamic Interface;

U.S. Pat. No. 6,382,634 Hydrodynamic Seal With Improved Extrusion Abrasion and Twist Resistance;

U.S. Pat. No. 6,334,619 Hydrodynamic Packing Assembly;

U.S. Pat. No. 6,315,302 Skew Resisting Hydrodynamic Seal;

U.S. Pat. No. 6,227,547 High Pressure Rotary Shaft Sealing Mechanism;

U.S. Pat. No. 6,120,036 Extrusion Resistant Hydrodynamically Lubricated Rotary Shaft Seal;

U.S. Pat. No. 6,109,618 Rotary Seal With Enhanced Lubrication and Contaminant Flushing;

U.S. Pat. No. 6,036,192 Skew and Twist Resistant Hydrodynamic Rotary Shaft Seal;

U.S. Pat. No. 6,007,105 Swivel Seal Assembly;

U.S. Pat. No. 5,873,576 Skew and Twist Resistant Hydrodynamic Rotary Shaft Seal;

U.S. Pat. No. 5,823,541 Rod Seal Cartridge for Progressing Cavity Artificial Lift Pumps;

U.S. Pat. No. 5,738,358 Extrusion Resistant Hydrodynamically Lubricated Multiple Modulus Rotary Shaft Seal;

U.S. Pat. No. 5,678,829 Hydrodynamically Lubricated Rotary Shaft Seal With Environmental Side Groove;

U.S. Pat. No. 5,230,520 Hydrodynamically Lubricated Rotary Shaft Seal Having Twist Resistant Geometry;

U.S. Pat. No. 5,195,754 Laterally Translating Seal Carrier For a Drilling Mud Motor Sealed Bearing Assembly;

U.S. Pat. No. 4,610,319 Hydrodynamic Lubricant Seal For Drill Bits;

United States Patent Applications:

Pub. No. 2005/0093246 Rotary Shaft Sealing Assembly;

Pub. No. 2006/0214379 Composite, High Temperature, Dynamic Seal and Method of Making Same;

Pub. No. 2009/0250881 Low Torque Hydrodynamic Lip Geometry for Bi-Directional Rotation Seals;

Pub. No. 2007/0013143 Filled Hydrodynamic Seal With Contact Pressure Control, Anti-Rotation Means and Filler Retention Means;

Pub. No. 2007/0205563 Stabilizing Geometry for Hydrodynamic Rotary Seals; and

Pub. No. 2009/0001671 Rotary seal with improved film distribution.

Assignee Kalsi Engineering manufactures various configurations of hydrodynamic rotary seals, and sells them under the registered trademark “KALSI SEALS.” The rotary seals that are marketed by Kalsi Engineering are installed with radial interference (i.e., compression), and seal by blocking the leak path. The seals employ various variable width dynamic lip geometries that cause a lubricant-side edge of a dynamic sealing interfacial contact footprint to be wavy. As a consequence of the wavy lubricant-side footprint edge, the rotary motion of the lubricant-wetted shaft drags lubricant into the dynamic sealing interface, and causes the seal to hydroplane on a film of lubricant that separates the seal from the shaft. This hydrodynamic operating regime allows the seal to operate cooler and with less wear, even under conditions of high differential pressure acting from the lubricant side of the seal.

The environment side of the interfacial contact footprint is intended to be circular rather than wavy, to avoid hydrodynamic activity with the environment, and thereby exclude the environment. Circumstances exist where the environment side of the footprint of prior art seals (and the “exclusion edge” of the seal) can become wavy, as a consequence of compression of the variable width dynamic lip geometry. Such waviness can encourage abrasive invasion of the dynamic sealing interface.

The interfacial contact pressure is managed from an abrasion resistance and interfacial lubrication standpoint by an “exclusion edge chamfer.” Independent of the exclusion edge chamfer, the interfacial contact pressure varies as a function of the local width of the dynamic lip. This lip-width induced variation causes the interfacial contact pressure to be higher than desired from an interfacial lubrication standpoint at some locations, and lower than desired from an abrasive exclusion standpoint at other locations. Certain operating conditions can also result in undesirable increases in interfacial contact pressure. When lubrication thus decreases, the seal generates undesirable heat due to increasing asperity friction, causing a loss of lubricant film viscosity and seal wear. The friction further increases seal temperature, compounding the problem.

It is desirable to be able to overcome the shortcomings described above. A sealing arrangement that provides a better way to manage exclusion edge circularity and interfacial contact pressure would be an advantage in many applications where long sealing life is needed to protect critical components in difficult operating conditions.

### SUMMARY OF THE INVENTION

The present invention is a rotary sealing arrangement that overcomes the above-described shortcomings of the prior art. Preferably, the seals are used to establish sealing between a machine component (such as a housing) and a relatively rotatable surface (such as a shaft), in order to separate a lubricating media from an environment. Seal geometry on a dynamic lip interacts with the lubricating media during relative rotation to wedge a lubricating film into the dynamic sealing interface between the seal and the relatively rotatable surface. A portion of the lubricating film migrates toward, and into, the environment and thus provides a contaminant flushing action.

The rotary seal includes a dynamic lip having local variations in width. The dynamic lip deforms when compressed into sealing engagement with the relatively rotatable surface, defining a hydrodynamic wedging angle with respect to the relatively rotatable surface, and defining an interfacial contact footprint of generally circular configuration but varying in width. A non-circular (e.g., wavy) footprint edge hydrodynamically wedges the lubricating film into the interfacial contact footprint.

An important aspect of a preferred embodiment of the present invention involves manufacturing an exclusion edge of the seal in a wavy pattern, to improve installed circularity of the exclusion edge, which improves environmental exclusion. The as-manufactured waviness of the exclusion edge also beneficially influences interfacial contact pressure by raising interfacial contact pressure in some locations, and lowering it at others, compared to the prior art.

A preferred embodiment of the invention is a generally circular, hydrodynamically lubricating rotary seal that is installed in a machine component that holds the seal in compressed relation with a relatively rotatable surface. The preferred embodiment of the invention manages exclusion edge circularity and interfacial contact pressure in ways that are advantageous to interfacial lubrication and environmental exclusion. The preferred embodiment of the invention includes several desirable features. The individual features can, however, be used separately when it is advantageous to do so due to operating conditions and/or when simplification is required by circumstances such as budgetary constraints.

It is intended that the rotary seals of the present invention may incorporate one or more seal materials without departing from the spirit or scope of the invention, and may be composed of any suitable sealing material, including elastomeric or rubber-like materials which may, if desired, be combined with various plastic materials such as reinforced polytetrafluoroethylene (“PTFE”) based plastic. If desired, the rotary seals may be of monolithic integral, one piece construction or may also incorporate different materials bonded, co-vulcanised, or otherwise joined together to form a composite structure.

The seal can be configured for dynamic sealing against a shaft, a bore, or a face. Simplified embodiments are possible wherein one or more features of the preferred embodiment are omitted.

One objective of the preferred embodiment of the present invention is to provide a hydrodynamic rotary seal having improved environmental exclusion. Another objective is reduced torque, for reduced wear and heat generation. Another objective is improved distribution of lubricant across the dynamic sealing interface, and correspondingly reduced seal wear, particularly in seals that are exposed to skew-resisting axial confinement and/or high differential pressure that may be acting from either side of the seal. Another objective is to enable the use of hydrodynamic inlet geometry that better accommodates high temperature operation in conditions of skew-resisting axial confinement.

### BRIEF DESCRIPTION OF THE SEVERAL VIEWS OF THE DRAWINGS

So that the manner in which the above recited features, advantages, and objects of the present invention are attained and can be understood in detail, a more particular description of the invention, briefly summarized above, may be had by reference to the embodiments thereof that are illustrated in the appended drawings. It is to be noted, however, that the appended drawings only illustrate preferred embodiments of this invention, and are therefore not to be considered limiting of its scope, for the invention may admit to other equally effective embodiments that vary only in specific detail.

In the drawings:

FIGS. 1A and 1B are fragmentary cross-sectional views representing an uncompressed cross-sectional configuration of a ring-shaped hydrodynamic seal having a dynamic sealing lip according to a preferred embodiment of the present invention, FIG. 1A is a view taken along lines 1A-1A of FIG. 1C at a narrow location of the dynamic sealing lip and FIG. 1B is a view taken along lines 1B-1B of FIG. 1C at a wide location of the dynamic sealing lip;

FIG. 1C is fragmentary plan view representing the uncompressed condition of the hydrodynamic features between the first and second body ends of the hydrodynamic seal of FIGS. 1A and 1B;

FIG. 1D is a fragmentary cross-sectional view of the hydrodynamic seal showing the compressed cross-sectional configuration in conjunction with first and second machine components, the view corresponding to the narrow location of the dynamic sealing lip shown in FIG. 1A;

FIG. 1E is a fragmentary cross-sectional view of the hydrodynamic seal showing the compressed cross-sectional configuration in conjunction with first and second machine components, the view corresponding to the wide location of the dynamic sealing lip shown in FIG. 1B;

FIG. 1F is a schematic representation of an exclusion edge of the hydrodynamic seal in the installed compressed condition and the uninstalled uncompressed condition, and includes a representation of the tendency of the prior art exclusion edge in an installed compressed condition;

FIG. 2 is a schematic representation similar to FIG. 1F in which the hydrodynamic seal has a different hydrodynamic inlet wave form than the seal of FIG. 1F; and

FIG. 3 is a fragmentary cross-sectional view of an alternate embodiment of the present invention showing the compressed cross-sectional configuration of a hydrodynamic seal in conjunction with first and second machine components.

### DESCRIPTION OF THE PREFERRED EMBODIMENTS

The ring-like rotary seal according to the preferred embodiments of the present invention is generally referred to as reference number 2 in the drawings. Features throughout this specification that are represented by like numbers have the same basic function.

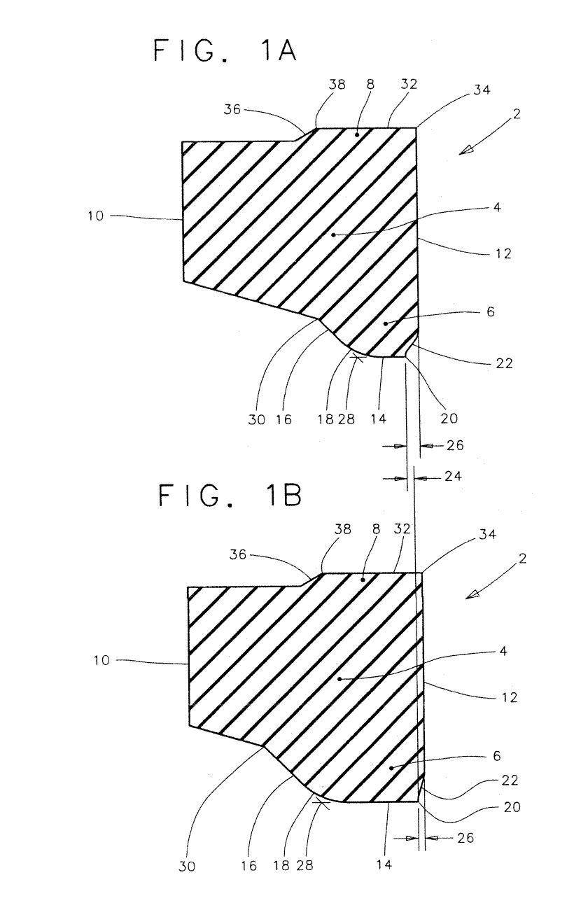

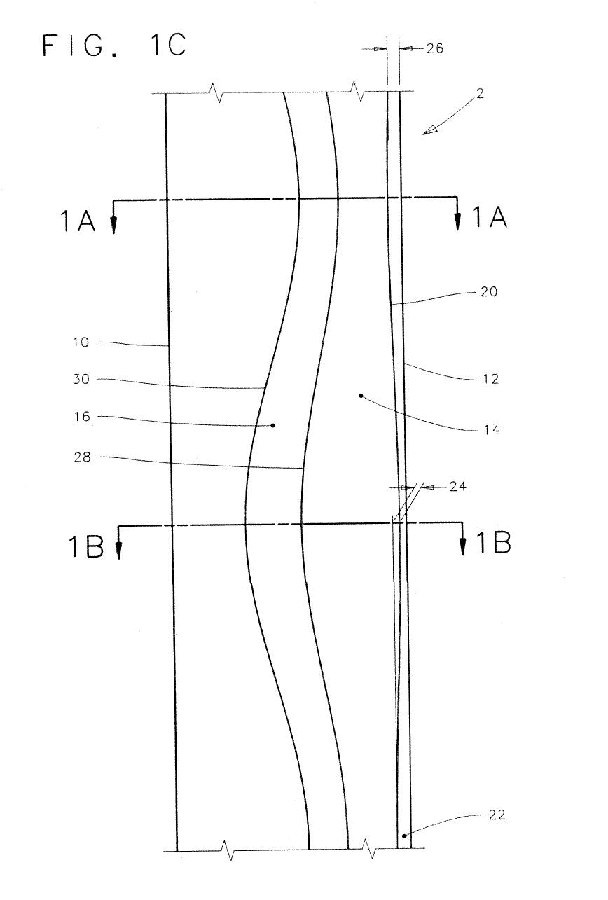

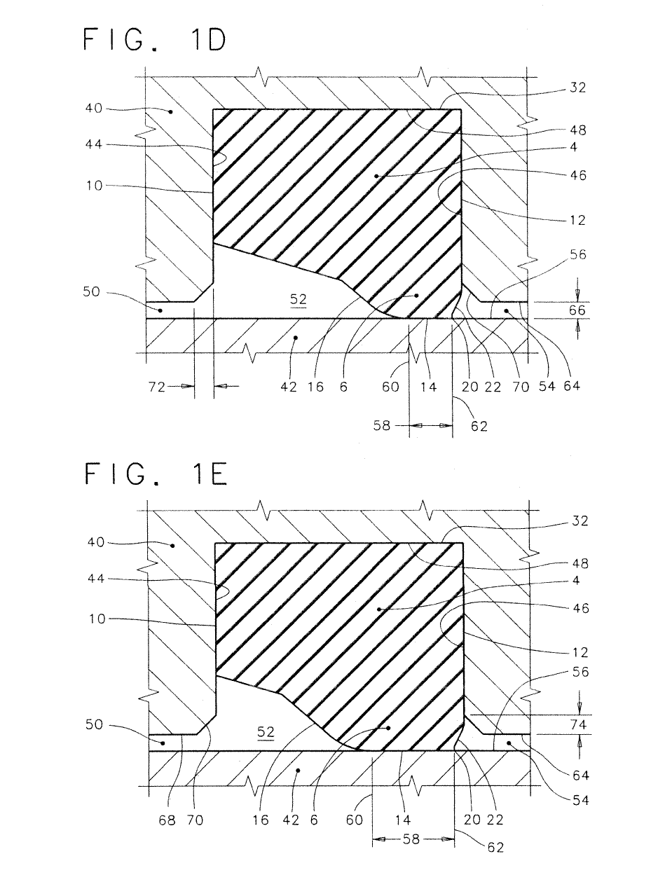

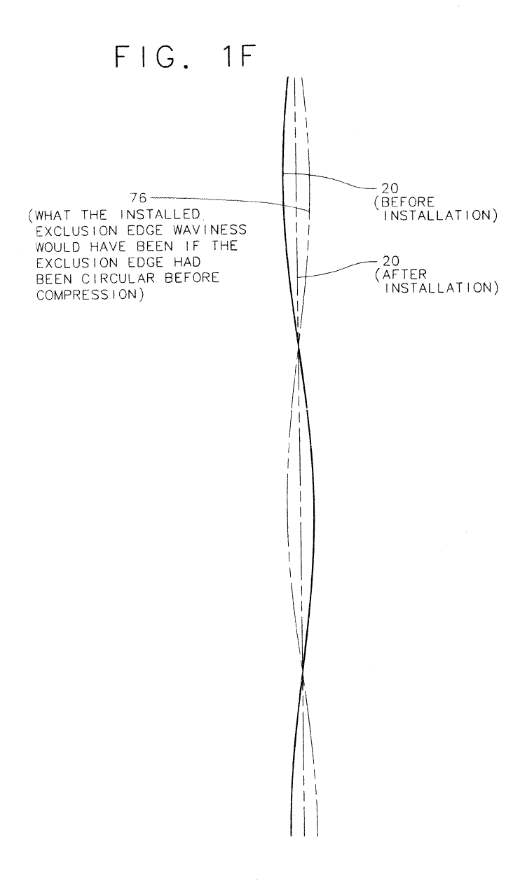

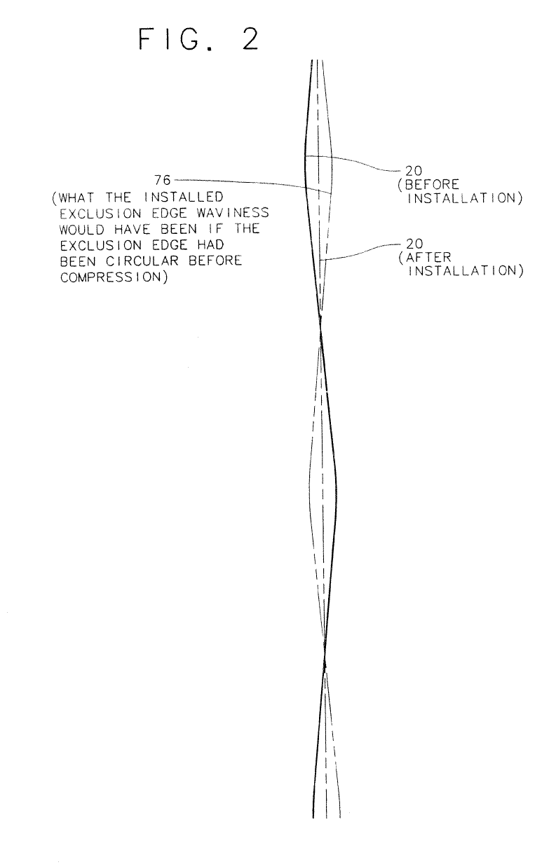

FIGS. 1A-1F

FIGS. 1A-1F are views representing a preferred embodiment of the present invention, and should be studied together, in order to attain a more complete understanding of the invention.

FIGS. 1A & 1B

FIGS. 1A and 1B are fragmentary views that represent the cross-sectional configuration of the rotary seal 2 at respective first and second locations before installation, and FIG. 1C is a fragmentary view of the seal that identifies the cutting planes that relate to the cross-sections of FIGS. 1A and 1B. FIGS. 1D and 1E are fragmentary views that represent the cross-sectional configuration of the rotary seal 2 at the same first and second locations after installation.

Referring now to FIGS. 1A and 1B, the rotary seal 2 is shown in an uncompressed, uninstalled condition. The rotary seal 2 has a ring-like seal body 4 of generally circular configuration. The term “ring-like” is used with the understanding that the term “ring” is commonly understood to encompass shapes other than those that are perfectly circular. As an example, a decorative finger ring often has beaded edges or a sculpted shape, yet is still called a ring. As another example, the key ring of U.S. Pat. No. 1,462,205 is not everywhere circular. There are thousands of precedents for using the term “ring-like” in a patent, and many patents use the term in conjunction with a seal or a body of a seal. For example, see U.S. Pat. Nos. 612,890, 4,361,332, 4,494,759, 4,610,319, 4,660,839, 4,909,520, 5,029,879, 5,230,520, 5,584,271, 5,678,829, 5,833,245, 5,873,576, 6,109,618, and 6,120,036. Note that in many of the examples, the seal in question has features that result in the shape not being everywhere circular; for example, in some cases the dynamic lip of the ring-like seal has a wavy lubricant-side shape.

The rotary seal 2 includes a dynamic sealing lip 6 of generally annular form that projects from the seal body 4. The rotary seal 2 incorporates a static sealing surface 32. The rotary seal 2 preferably also includes a static sealing lip 8 that projects from the seal body 4 in generally opposed relation to the dynamic sealing lip 6, as taught by the prior art.

As used herein, the “modulus” or “elastic modulus” of an elastomer can be estimated in accordance with FIG. 1 of ASTM D 1415-83, Standard Test Method for Rubber Property—International Hardness. Rotary seal 2 is constructed of sealing material which is preferably an elastomer compound or a combination of one or more elastomer compounds, or a combination of a suitable plastic and an elastomer compound, as taught by the prior art. For example, the region of the seal comprising the dynamic sealing lip 6 could be made from a first material, and the region comprising the static sealing surface 32 and/or the static sealing lip 8 could be made from a second material. As taught by commonly assigned U.S. Pat. No. 5,738,358, the first material could have a higher elastic modulus, compared to that of the second material. As taught by commonly assigned Canadian Pat. No. 2601282, the first material could be selected based on its dynamic characteristics, and the second material could be selected based on its compression set resistance characteristics.

It is commonly understood by those having ordinary skill in the art that elastomers used in seal construction are compounds that include one or more base elastomers. Such base elastomers include, but not limited to, I-INBR (highly saturated nitrile elastomer), FKM (fluorocarbon rubber), FEPM (also known as TFE/P or Tetrafluoroethylene and Propylene Copolymer), and EPDM. Such compounds may include other compounding agents including fillers, processing aids, anti-degradants, vulcanizing agents, accelerators and activators. The effects of the ingredients used are generally understood by those of ordinary skill in the art of compounding elastomers. Likewise, the ingredients used in manufacturing plastics that are used in seal construction are generally understood by those of ordinary skill in the art of developing plastic seal materials.

The seal body 4 has a first body end 10 and a second body end 12. The seal body 4, being a generally circular, ring-like entity, defines a theoretical centerline/axis (not shown). For orientation purposes, it should be understood that in all of the cross-sectional views herein, the cutting plane of the cross-section is aligned with and passes through the theoretical axis of the rotary seal 2. The first body end 10 of rotary seal 2 is located in generally opposed relation to the second body end 12. Within the seal industry, the first body end 10 of rotary seal 2 is sometimes referred to as the “lubricant end,” and the second body end 12 is sometimes referred to as the “environment end.”

Preferably, the size of the dynamic sealing lip 6 is not uniform, but instead varies, to produce a sealing interface of variable width when installed, in order to cause hydrodynamic wedging activity in response to relative rotation. For example, the size of dynamic sealing lip 6 is smaller at the first location of FIG. 1A, compared to the size at the second location of FIG. 1B, as taught by the prior art. This intentional variation in the size of the dynamic sealing lip 6 is accomplished by varying one or more dimensions of the dynamic sealing lip 6, in accordance with the teachings of the commonly assigned patents and patent applications noted above.

Prior art patents and patent publications teach that almost any dimension of the dynamic sealing lip 6 can be varied to cause the size of the dynamic sealing lip 6 to vary, and produce a dynamic interface of variable width when installed, and to cause hydrodynamic wedging activity in response to relative rotation when installed. For example, U.S. Pat. No. 4,610,319 teaches that the width of the dynamic lip can be varied to achieve hydrodynamic wedging activity, U.S. Pat. No. 6,685,194 teaches that the slope and/or curvature of the dynamic lip can be varied to produce hydrodynamic wedging activity, and U.S. Pat. Nos. 6,109,618 and 7,562,878 show that the geometry of a dynamic sealing lip can be varied in complex ways to achieve hydrodynamic wedging activity.

When pressed against a relatively rotatable surface, the dynamic sealing lip 6 establishes a sealing interface with respect to the relatively rotatable surface that has a non-circular, wavy lubricant-side edge, in accordance with the above-noted commonly assigned patents and patent applications. Examples of such a wavy lubricant-side edge can be seen in FIGS. 2-8 of U.S. Pat. No. 4,610,319, FIG. 13 of U.S. Pat. No. 5,230,520, FIG. 2F of U.S. Pat. No. 6,109,618, and FIGS. 2 and 2A-2C of U.S. Pat. No. 7,562,878. The sealing interface is sometimes referred to as the interfacial contact footprint, to facilitate visualization of what is being referred to.

The dynamic sealing lip 6 incorporates a dynamic sealing surface 14. The cross-sectional profile of the dynamic sealing surface 14 can be any suitable shape, including straight or curved lines or line combinations, and including shapes that vary at different locations of the dynamic sealing lip 6. Many such shapes are taught by the prior art.

The dynamic sealing lip 6 preferably has a lubricant side flank 16 that is non-circular; and preferably wavy. The lubricant side flank 16 is preferably blended to the dynamic sealing surface 14 by a blending feature 18 over at least part of the circumference of seal body 4. This blending feature 18 can take many different forms, including forms that vary in shape about the circumference of the seal body 4. Many such shapes are taught by the prior art.

The dynamic sealing surface 14 of the dynamic sealing lip 6 also incorporates an exclusion edge 20 that preferably has generally abrupt form. If desired, the exclusion edge 20 can be formed by an intersection between the dynamic sealing surface 14 and a flexible transitional heel 22, as shown. The flexible transitional heel 22 can also be referred to as the “exclusion edge chamfer.”

The exclusion edge 20 of the preferred embodiment of the present invention differs radically and counter-intuitively from that of the prior art. In the prior art, the exclusion edge is manufactured to be circular in the uninstalled condition. It has recently been discovered that the exclusion edge of the prior art becomes slightly wavy/less circular upon installation. The exclusion edge 20 of the preferred embodiment of the present invention is intentionally manufactured to be non-circular in the uncompressed condition of the rotary seal 2, so that it is slightly wavy in a manner that is timed to the varying size of the dynamic sealing lip 6. This uninstalled waviness has a waviness height 24.

Unlike the prior art, the exclusion edge 20 of the present invention is intentionally wavy in the uninstalled condition, but becomes more circular/less wavy upon installation of rotary seal 2. This provides improved environmental exclusion, compared to the prior art, by minimizing skew-induced wear. The waviness of the exclusion edge 20 in the uncompressed condition of the rotary seal 2 is engineered to compensate for the trend toward waviness that compression of the dynamic sealing lip 6 causes, so that in the compressed condition, the exclusion edge 20 becomes much less wavy than would otherwise be the case.

The flexible transitional heel 22 has a heel width 26 which, in the uncompressed condition, is different in size at the first location, represented by FIG. 1A, compared to the second location, represented by FIG. 1B. This variation in size from one location to another is a wavy variation in size that is substantially in time with the locally changing size of the dynamic sealing lip 6, and is substantially in time with the waviness of the exclusion edge 20.

This variation in size of the heel width 26 from one location to another influences local interfacial contact pressure near the exclusion edge 20 when the rotary seal 2 is compressed. For example, consider a comparison to a prior art seal with a fixed, non-varying heel width that has a width dimension of “X” inches. In the present invention, the local interfacial contact pressure near the exclusion edge 20 would be greater than that of the prior art near where the heel width 26 is larger than dimension “X”, and would be less than that of the prior art near where the heel width 26 is less than dimension “X”.

Fittingly, the increases in interfacial contact pressure over that of the prior art occur where such increases are desirable from an environmental exclusion standpoint, and the reductions in contact pressure over that of the prior art occur where such reductions are desirable from an interfacial lubrication standpoint.

In the example of FIGS. 1A and 1B, the variation in the heel width 26 establishes the waviness height 24 of the exclusion edge 20. The heel width 26 variations that are needed to establish the correct uncompressed waviness of the exclusion edge 20 are also the variations that are desirable to beneficially manage interfacial contact pressure in the manner discussed in the previous two paragraphs.

The static sealing lip 8 preferably incorporates a static exclusionary intersection 34. If desired, the static exclusionary intersection 34 can be formed by an intersection between the second body end 12 and the static sealing surface 32, as shown. The specific shape of the static sealing lip 8 can vary from the shape that is shown without departing from the spirit or scope of the invention. For example, the static sealing surface 32 could be slightly conical/sloped, as taught by commonly assigned U.S. Pat. No. 7,052,020. Preferably, a static lip flank 36 intersects the static sealing surface 32 to form a static lip corner 38.

For the sake of the description that is needed in conjunction with the illustration of FIG. 1C, the theoretical intersection 28 between the lubricant side flank 16 and the dynamic sealing surface 14, and also the body intersection 30 between the lubricant side flank 16 and the seal body 4 are identified on the seal that is illustrated in FIGS. 1A and 1B. This is being done simply for the sake of discussion and comprehension, with the understanding that not every hydrodynamic seal that has a dynamic sealing lip 6 of varying size will have a theoretical intersection 28 and/or a body intersection 30.

FIG. 1C

FIG. 1C is a fragmentary view that represents the same rotary seal 2 that is shown in FIGS. 1A and 1B, and like those figures, also represents the uncompressed condition of rotary seal 2. FIG. 1A corresponds to the location identified by cutting plane 1A-1A, and FIG. 1B corresponds to the location identified by cutting plane 1B-1B. To minimize curvature-related foreshortening in FIG. 1C, for ease of comprehension, FIG. 1C has been drawn to represent how a seal that is relatively large or infinite in diameter would appear, or how a smaller seal would appear if a short portion thereof was forced straight. By using this illustration premise, the visually confusing effects of curvature-related foreshortening are absent or negligible, and can be ignored.

Several features in FIG. 1C are numbered for the purpose of orienting the reader; namely: first body end 10, second body end 12, dynamic sealing surface 14, lubricant side flank 16, exclusion edge 20, flexible transitional heel 22, waviness height 24, heel width 26, theoretical intersection 28, and body intersection 30. In keeping with American drafting third angle projection conventional representation, the theoretical intersection 28 is represented by a solid line even though the intersection would typically be blended by a blending feature. For a discussion of this general blended intersection illustration practice, see paragraph 7.36 and FIG. 7.44(b) on page 213 of the classic drafting textbook “Technical Drawing,” (Prentice-Hall, Upper Saddle River, N.J., 10th edition (1997)).

The theoretical intersection 28, which is not applicable on all hydrodynamic seal designs, is illustrated merely to convey the sense that the dynamic sealing lip 6 varies in size, as a matter of convenience. It is understood that, as taught by the various commonly assigned prior art, seal designs are possible where the dynamic sealing lip 6 varies in size, but the surfaces of the dynamic sealing lip are such that no theoretical intersection can be defined.

The main point of FIG. 1C is that it shows the variation in size of the heel width 26 of the flexible transitional heel 22, and shows the waviness and waviness height 24 of the exclusion edge 20. The waviness of the theoretical intersection 28 and body intersection 30 show that the dynamic lip varies in size from cutting plane 1A-1A to cutting plane 1B-1B.

FIGS. 1D & 1E

Referring now to FIGS. 1D and 1E, the rotary seal 2 is shown in its installed condition. The cross-sections of FIGS. 1D and 1E are fragmentary longitudinal cross-sectional illustrations that correspond to the uncompressed cross-sections of FIGS. 1A and 1B, respectively. The cross-sections of FIGS. 1D and 1E relate to cutting planes that pass through the theoretical centerline/axis of the seal; i.e., the theoretical centerline lies on the cutting plane. The circumferential direction of relative rotation is normal (perpendicular) to the plane of the cross-section, and the theoretical centerline of rotary seal 2 generally coincides with the axis of relative rotation.

Rotary seal 2 is oriented (i.e., positioned) by the first machine component 40 for sealing with respect to a relatively rotatable surface 56 of a second machine component 42. For the purpose of illustrating a typical application, the first machine component 40 is illustrated as having a generally circular seal groove that is defined by a first wall 44, a second wall 46 and a peripheral wall 48.

An extrusion gap bore 64 establishes an extrusion gap clearance 66 with respect to the relatively rotatable surface 56 of the second machine component 42. Part of a chamber 50 is typically formed by a component bore 68 and the relatively rotatable surface 56. The transition between the second wall 46 and the extrusion gap bore 64 and the transition between the first wall 44 and the component bore 68 preferably takes the form of a corner break 70, such as a radius or other form of curve, or such as a chamfer (the latter being illustrated). The corner break 70 preferably has a width 72 and a depth 74. The width 72 and depth 74 may be the same size, or different in size relative to one another. The first wall 44 and the second wall 46 are in generally opposed relation to one another. Within the seal industry, the first wall 44 is sometimes referred to as the “lubricant-side wall,” and the second wall 46 is sometimes referred to as the “environment-side wall.”

Although the first wall 44 and the second wall 46 are shown to be in fixed, permanent relation to one another, such is not intended to limit the scope of the invention, for the manner of positioning the rotary seal 2 admits to other equally suitable forms. For example, the first wall 44 and/or the second wall 46 could be configured to be detachable from the first machine component 40 for ease of maintenance and repair, but then assembled in more or less fixed location for locating the rotary seal 2. For another example, it is common in some types of equipment for the first wall 44 to be part of a ring that is spring-loaded to force the rotary seal 2 into contact with the second wall 46 for reasons of skew avoidance. For yet another example, a detachable gland wall may be mandated when the rotary seal 2 is small in diameter, because such small seals cannot be deformed sufficiently to be installed within a groove that has fixed, non-detachable gland walls. The first body end 10 of rotary seal 2 generally faces the first wall 44, and the second body end 12 of rotary seal 2 generally faces the second wall 46.

First machine component 40 and second machine component 42 together typically define at least a portion of the chamber 50, which is typically used for locating a retained fluid 52 and for defining a lubricant supply. The retained fluid 52 is preferably exploited in this invention to lubricate the dynamic sealing interface between rotary seal 2 and the second machine component 42 during relative rotation thereof. Retained fluid 52 is preferably a liquid-type lubricant such as a synthetic or natural oil, although other fluids including greases, water, and various process fluids are also suitable in some applications. An environment 54 may be any type of environmental media that the rotary seal 2 may be exposed to in service, such as any type of solid, liquid, or gaseous environmental media including, but not limited to, dirt, crushed rock, drilling fluid, manure, dust, lubricating media, a process media, seawater, air, a partial vacuum, etc. For purposes of this specification, the term “fluid” has its broadest meaning, encompassing both liquids and gases.

The purpose of rotary seal 2 is to establish sealing engagement with the relatively rotatable surface 56 of the second machine component 42 and with the first machine component 40, to retain a volume of the retained fluid 52, to partition the retained fluid 52 from the environment 54, and to exclude the environment 54 and prevent intrusion of the environment 54 into the retained fluid 52.

Relatively rotatable surface 56 of second machine component 42 and peripheral wall 48 of first machine component 40 are in spaced relation to each other. The spacing of relatively rotatable surface 56 and peripheral wall 48 is sized to hold rotary seal 2 in compression. In the same manner as any conventional interference-type seal, such as an O-ring or an O-ring energized lip seal, the compression of rotary seal 2 establishes sealing between static sealing lip 8 of rotary seal 2 and peripheral wall 48 of first machine component 40, and establishes sealing between the dynamic sealing lip 6 of rotary seal 2 and the relatively rotatable surface 56 of second machine component 42.

A portion of the static sealing surface 32 is typically in compressed contact with the peripheral wall 48. At least a portion of the dynamic sealing lip 6 is held in compressed, contacting relation with relatively rotatable surface 56 of the second machine component 42. In dynamic operation, the relatively rotatable surface 56 has relative rotation with respect to dynamic sealing lip 6 of the rotary seal 2 and with respect to the first machine component 40. The preferred embodiment of the present invention has application where either the first machine component 40 or the second machine component 42, or both, are individually rotatable.

The compression (i.e., compressed, contacting relation) of dynamic sealing lip 6 against the relatively rotatable surface 56 establishes and defines a sealing interface/interfacial contact footprint between dynamic sealing lip 6 and relatively rotatable surface 56, as taught by the commonly assigned prior art identified above. The sealing interface has a footprint width 58 that is greater at the location of FIG. 1E, compared to FIG. 1D. The footprint has a non-circular first footprint edge 60 that faces the retained fluid 52, and a second footprint edge 62 of generally circular configuration that faces the environment 54 (the footprint edges identified by referencing the extension lines of the dimension for the footprint width 58).

Thus, the footprint width 58 varies about the circumference of seal body 4 from a minimum width to a maximum width, as taught by the commonly assigned prior art. FIG. 1D is representative of a location of the dynamic sealing lip 6 that produces the minimum footprint width 58, and FIG. 1E is representative of a location of the dynamic sealing lip 6 that produces the maximum footprint width 58.

The exclusion edge 20 of dynamic sealing lip 6, which was manufactured slightly wavy, becomes less wavy and more circular when installed. Because of this unique feature, the present invention provides better alignment between the exclusion edge 20 and the direction of relative rotation, and is adapted to better-exclude intrusion of the environment 54, compared to the prior art. Exclusion edge 20 is of a configuration intended to develop substantially no hydrodynamic wedging activity during relative rotation between dynamic sealing lip 6 and relatively rotatable surface 56. Exclusion edge 20 presents a scraping edge to help exclude contaminant material from the interfacial contact footprint between dynamic sealing lip 6 and relatively rotatable surface 56, in the event of any relative movement occurring perpendicular to the direction of relative rotation between dynamic sealing lip 6 and relatively rotatable surface 56 (i.e., movement occurring from right to left or left to right in FIGS. 1D and 1E).

When relative rotation is absent, a liquid-tight static sealing relationship is maintained at the interface between dynamic sealing lip 6 and relatively rotatable surface 56, and between static sealing surface 32 and peripheral wall 48. When relative rotation occurs between first machine component 40 and relatively rotatable surface 56, the rotary seal 2 preferably remains stationary with respect to peripheral wall 48 of first machine component 40 and maintains a static sealing relationship therewith, while the interface between dynamic sealing lip 6 and relatively rotatable surface 56 of second machine component 42 becomes a dynamic sealing interface, such that relatively rotatable surface 56 slips with respect to dynamic sealing lip 6 at a given rotational velocity. When relative rotation between dynamic sealing lip 6 and relatively rotatable surface 56 ceases, the sealing interface/interfacial contact footprint between dynamic sealing lip 6 and relatively rotatable surface 56 returns to being a static sealing interface.

Because the footprint between dynamic sealing lip 6 and relatively rotatable surface 56 has a first footprint edge 60 that is intentionally non-circular (e.g., wavy), it, in conjunction with the defoinied shape of dynamic sealing lip 6, produces a hydrodynamic wedging action in response to relative rotation between the rotary seal 2 and relatively rotatable surface 56. This hydrodynamic wedging action forces a film of the retained fluid 52 into the interfacial contact footprint between the dynamic sealing lip 6 and relatively rotatable surface 56 for lubrication purposes, which reduces wear, torque and heat generation. In other words, dynamic sealing lip 6 slips or hydroplanes on a film of lubricating fluid during periods of relative rotation between the dynamic sealing lip 6 and relatively rotatable surface 56. When relative rotation stops, the hydroplaning activity stops, and a static sealing relationship is re-established between dynamic sealing lip 6 and relatively rotatable surface 56 due to the compression of dynamic sealing lip 6 against relatively rotatable surface 56.

The hydroplaning activity that occurs during relative rotation minimizes or prevents the typical dry rubbing wear and high friction associated with conventional non-hydrodynamic rubber and plastic seals, prolonging the useful life of the rotary seal 2 and the life of the relatively rotatable surface 56, and making higher speed, compression and differential pressure practical. During relative rotation, a net hydrodynamic-pumping related leakage of the retained fluid 52 occurs as lubricant is transferred across the dynamic sealing interface and into the environment 54.

Due to second footprint edge 62 being substantially circular and substantially aligned with the possible directions of relative rotation, second footprint edge 62 does not produce a hydrodynamic wedging action in response to relative rotation between the dynamic sealing lip 6 and the relatively rotatable surface 56, thereby facilitating exclusion of the environment 54.

Since perfect theoretical circularity is seldom if ever obtainable in any feature of any manufactured product in practice, it is to be understood that when “circular,” “substantially circular,” or “substantial circularity” or similar terms are used to describe achievements or feature attributes of the invention that is described and claimed herein, what is meant is that circularity is improved, so that there is less waviness or other deviation from perfect theoretical circularity, compared to the prior art under similar installed conditions. For example, it is one objective of a preferred embodiment of the current invention to improve the circularity (i.e., achieve less waviness) of the exclusion edge 20 and the corresponding environment side of the interfacial contact footprint in conditions of little or no differential pressure compared to the prior art. This objective is not to be misconstrued as an intent to achieve the unobtainable; i.e., perfect theoretical circularity.

The non-circular, wavy configuration of first footprint edge 60 can take any desirable form where at least a portion is skewed with respect to the direction of relative rotation, and can take the form of one or more repetitive or non-repetitive convolutions/waves of any form including a sine, saw-tooth or square wave configuration, or plural straight or curved segments forming a tooth-like pattern, or one or more parabolic curves, cycloid curves, witch/versiera curves, elliptical curves, etc. or combinations thereof, including, but not limited to, any of the lubricant-side footprint edge configurations shown in U.S. Pat. Nos. 4,610,319, 6,109,618, 6,685,194, and 7,562,878.

Compared to the prior art, the wavy as-manufactured geometry of the flexible transitional heel 22 as shown in FIGS. 1A-1C causes the interfacial contact pressure between the dynamic sealing lip 6 and the relatively rotatable surface 56 to be greater where such is desirable for improved exclusion, and causes the interfacial contact pressure to be less where such is desirable for improved lubrication. In the prior art, the heel width was constant in the as-manufactured state, but varied in a wavy pattern when the seal was installed. In the present invention, the heel width and the exclusion edge 20 are wavy in the as-manufactured state, and become less wavy in the installed state. In other words, the as-manufactured waviness of the heel width, and of the exclusion edge 20, are designed to compensate for and largely correct the tendency of the features to otherwise become wavy due to compression. The as manufactured waviness is made in a form that is opposite the compression-induced waviness tendency, in order to compensate for the compression-induced waviness tendency. This concept is clarified below in the description of FIG. 2.

The seal body 4 of rotary seal 2 is illustrated as having an installed length that causes it to simultaneously contact the second wall 46 and the first wall 44 in certain operating conditions, in accordance with the axial constraint teachings of commonly assigned U.S. Pat. No. 6,315,302. In other words, the first body end 10 of seal body 4 is illustrated as contacting the first wall 44 of first machine component 40, and the second body end 12 of seal body 4 is illustrated as contacting the second wall 46 of first machine component 40, in order to inhibit skew-induced wear. This is not meant to imply that the invention is limited to seals that have axial constraint. The teachings of the invention are also applicable to seals where seal body 4 has an installed length that is shorter than the distance between the second wall 46 and the first wall 44.

Relatively rotatable surface 56 can take the form of an externally or internally oriented substantially cylindrical surface, as desired, with rotary seal 2 compressed radially between peripheral wall 48 and relatively rotatable surface 56, in which case the axis of relative rotation would be substantially parallel to relatively rotatable surface 56. In a radial sealing configuration, dynamic sealing lip 6 is oriented for compression in a substantially radial direction, and peripheral wall 48 may, if desired, be of substantially cylindrical configuration, and first wall 44 and second wall 46 may, if desired, be of substantially planar configuration.

Alternatively, relatively rotatable surface 56 can take the form of a substantially planar surface, with rotary seal 2 compressed axially between peripheral wall 48 and relatively rotatable surface 56 in a “face-sealing” arrangement, in which case the axis or relative rotation would be substantially perpendicular to relatively rotatable surface 56. In an axial (face) sealing configuration, dynamic sealing lip 6 would be oriented for compression in a substantially axial direction, peripheral wall 48 may be of substantially planar configuration, and first wall 44 and second wall 46 may, if desired, be of substantially cylindrical configuration. In the most common configuration, relatively rotatable surface 56 is an external cylindrical surface formed by an exterior surface of a shaft or sleeve.

In summary, the seal can be used as a radial seal or a face seal by configuring the dynamic sealing lip 6 to be located at either the inside diameter, the outside diameter, or the end of the seal, while maintaining the advantages of the invention that are disclosed herein. In a preferred embodiment, a performance advantage is realized by implementing the depth 74 and width 72 in such a manner that the former is at least 2.5 times greater than the latter, and preferably approximately three times greater. Simplified embodiments are possible wherein one or more of the features that are described above are omitted. Alternate embodiments are also possible, where one or more of the features that are described above are combined with different features of the prior art. For example, in the uncompressed condition thereof, dynamic sealing surface 14 and/or static sealing surface 32 may, if desired, be of sloped configuration, angulated with respect to the respective mating surfaces of the first machine component 40 and second machine component 42, in accordance with the teachings of commonly assigned U.S. Pat. No. 6,767,016.

FIG. 1F

FIG. 1F is a schematic of the exclusion edge 20 of the seal that is disclosed in FIGS. 1A-1E. A solid line shows the wavy shape of exclusion edge 20 before seal installation. A phantom line shows the more circular shape of exclusion edge 20 after seal installation. A phantom line 76 shows what the installed exclusion edge waviness would have been if the exclusion edge had been circular before installation. FIG. 1F shows that the pre-installation shape of the exclusion edge 20 is engineered to compensate for the waviness that would otherwise occur.

FIG. 2

FIG. 2 is a schematic that shows that the principles taught herein can be applied to seals that have hydrodynamic inlet wave forms other than the simple sine wave that is shown in FIG. 1C. Referring to FIG. 2, a solid line shows the wavy shape of exclusion edge 20 before seal installation. A phantom line shows the more circular shape of exclusion edge 20 after seal installation. A phantom line 76 shows what the installed exclusion edge waviness would have been if the exclusion edge had been circular before installation. In FIG. 2, the waviness of the exclusion edge 20 before installation is not sinusoidal; rather it has more of the character of a zig-zag with blended corners, in order to be used with dynamic lips that vary locally in size in the manner shown by FIGS. 2A, 3, 4, 8, and 10 of commonly assigned U.S. Patent Application Publication No 2009/0001671.

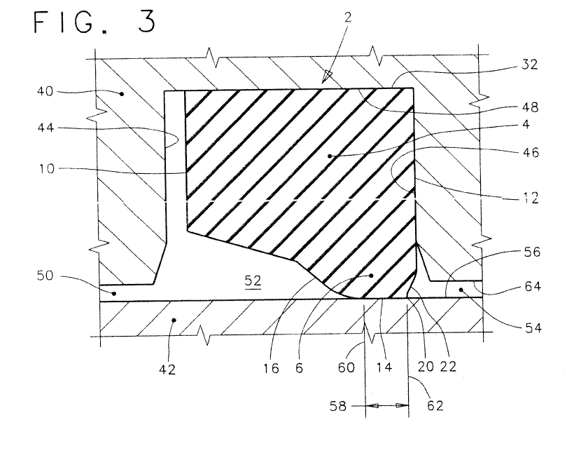

FIG. 3

FIG. 3 shows an alternate embodiment of the present invention, where the rotary seal 2 is shown in its installed condition. FIG. 3 illustrates that the principles taught herein are applicable to assemblies that do not use the principle of axial constraint that is taught by commonly assigned U.S. Pat. No. 6,315,302, and illustrated in FIGS. 1D and 1E herein. Note that the seal body 4 is not in simultaneous contact with the first wall 44 and the second wall 46 of the groove of the first machine component 40. In FIG. 3, various features of the seal and machine components are labeled to orient the reader, bearing in mind that features throughout this specification that are represented by like numbers have the same basic function.

In FIG. 3, the rotary seal 2 is shown located in a position within the seal groove that would occur if the pressure of the retained fluid 52 were higher than the pressure of the environment 54. In such pressure conditions, the hydrostatic force resulting from the lubricant pressure acting over the area between the relatively rotatable surface 56 and peripheral wall 48 forces the second body end 12 of the rotary seal 2 against the second wall 46. This leaves a gap between the first body end 10 and the first wall 44. If the pressure were in the opposite direction, such that the pressure of the environment 54 were higher than the pressure of the retained fluid 52, the seal would slide in response to the differential pressure, bringing the first body end 10 into supporting contact with the first wall 44, and opening up a gap between the second body end 12 and the second wall 46.

In view of the foregoing it is evident that the present invention is one that is well adapted to attain all of the objects and features hereinabove set forth, together with other objects and features which are inherent in the apparatus disclosed herein. Even though several specific hydrodynamic rotary seal and seal gland geometries are disclosed in detail herein, many other geometrical variations employing the basic principles and teachings of this invention are possible.

The foregoing disclosure and description of the invention are illustrative and explanatory thereof, and various changes in the size, shape and materials, as well as in the details of the illustrated construction, may be made without departing from the spirit of the invention. The present embodiments are, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A hydrodynamic seal comprising:
a seal body of generally ring-shaped configuration having a circumference, a static sealing surface, a first end and a second end in generally opposed relation to said first end, and a dynamic sealing lip projecting from said seal body;
said dynamic sealing lip having a cross-sectional area that varies along said circumference, said dynamic sealing lip defining an exclusion edge having a substantially abrupt form, wherein said exclusion edge is non-circular and slightly wavy in an uninstalled condition of the hydrodynamic seal.

2. The hydrodynamic seal of claim 1, wherein said dynamic sealing lip includes a dynamic sealing surface and said exclusion edge is formed by an intersection between said dynamic sealing surface and a flexible transitional heel.

3. The hydrodynamic seal of claim 2, wherein said flexible transitional heel has a heel width varying in size substantially in time with said varying cross-sectional area of said dynamic sealing lip in the uninstalled condition.

4. A hydrodynamic sealing assembly for partitioning a first fluid from a second fluid and to exclude intrusion of the second fluid into the first fluid, the hydrodynamic sealing assembly comprising:
a first machine component having first and second walls and a peripheral wall defining a seal groove;
a second machine component having a rotatable surface that is rotatable relative to said first machine component; and
a hydrodynamic seal comprising a seal body of generally ring-shaped configuration having a circumference, said seal body comprising:
a dynamic sealing lip having a dynamic sealing surface contacting said relatively rotatable surface to establish a dynamic sealing interface between said dynamic sealing lip and said relatively rotatable surface, and including an exclusion edge of abrupt substantially circular form that is substantially aligned with a direction of relative rotation between said dynamic sealing lip and said relatively rotatable surface in a compressed, installed condition;
a static sealing lip of annular form having a static sealing surface contacting a first portion of said peripheral wall; and
wherein said exclusion edge is non-circular and slightly wavy in an uncompressed, uninstalled condition of said hydrodynamic seal.

5. The hydrodynamic sealing assembly of claim 4, wherein said dynamic sealing lip has a cross-sectional area that varies along said circumference,

6. The hydrodynamic sealing assembly of claim 5, wherein said exclusion edge is formed by an intersection between said dynamic sealing surface and a flexible transitional heel.

7. The hydrodynamic sealing assembly of claim 6, wherein said flexible transitional heel has a heel width varying in size substantially in time with said varying cross-sectional area of said dynamic sealing lip in the uncompressed, uninstalled condition.
